(19) United States
(12) Patent Application Publication
(10) Pub. No.: US 2017/0198209 A1
(43) Pub. Date: Jul. 13, 2017

(54) PROPPANT-BASED CHEMICAL DELIVERY SYSTEM

(71) Applicant: Imerys Oilfield Minerals, Inc., Roswell, GA (US)

(72) Inventors: Christopher STEPHENSON, Houston, TX (US); Gregory BOISSON, Atlanta, GA (US); Roberto Boehringer MARTINEZ, Denver, CO (US); Eric SCHILL, The Woodlands, TX (US); Darrel BRIDGEMOHAN, Cypress, TX (US)

(21) Appl. No.: 15/321,068

(22) PCT Filed: Jun. 25, 2015
(86) PCT No.: PCT/US15/37743

§ 371 Date: Dec. 21, 2016

Related U.S. Application Data
(60) Provisional application No. 62/018,270, filed on Jun. 27, 2014.

(51) Int. Cl. C09K 8/80; C04B 33/13; C04B 33/32; E21B 43/267; C04B 35/634; C04B 35/638; C04B 35/626; C04B 35/64; C04B 33/04; C04B 35/14

(52) U.S. Cl. CPC C09K 8/80; C04B 33/04; C04B 33/131; C04B 33/1305; C04B 33/32; C04B 35/14; C04B 35/63416; C04B 35/638; C04B 35/62695; C04B 35/64; E21B 43/267; C04B 2235/349; C04B 2235/3418; C04B 2235/656; C04B 2235/6567; C04B 2235/77; C04B 2235/94; C04B 2235/96

(57) ABSTRACT

A proppant composition may include at least about 50 wt % total silica and up to about 50 wt % total alumina and a connected porosity greater than or equal to about 5%. A proppant precursor composition may include an alumina- or aluminosilicate-containing material and diatomaceous earth, wherein the diatomaceous earth may be greater than or equal to about 25 wt %. A method of making a proppant may include mixing an alumina- or aluminosilicate-containing material and diatomaceous earth to form a precursor composition, pelletizing the precursor composition, and sintering the pelletized precursor composition to form a sintered proppant having a connected porosity greater than or equal to about 5%. A method of treating a fracture site may include delivering a sintered proppant including an active agent to a well site, and dispersing the active agent from the sintered proppant within the well site.

### CLAIM FOR PRIORITY

This PCT International Application claims the benefit of priority of U.S. Provisional Application No. 62/018,270, filed Jun. 27, 2014, the subject matter of which is incorporated herein by reference in its entirety.

### DESCRIPTION

Field of the Disclosure

The present disclosure relates to proppant-based chemical delivery systems and methods of making and using proppants for chemical delivery.

Background of the Disclosure

Naturally occurring deposits containing oil and natural gas have been located throughout the world. Because of the porous and permeable nature of the subterranean structure, wells are bored into the earth to pump the oil and natural gas out of the deposit. These wells are large, costly structures that are typically fixed at one location. A well may initially be very productive, with the oil and natural gas being pumpable with relative ease. As oil or natural gas near the well bore is removed from the deposit, other oil and natural gas may flow to the area near the well bore and may be removed by the well. As a well ages, however, and sometimes merely as a consequence of the subterranean geology surrounding the well bore, more remote oil and natural gas deposits may not flow easily to the well bore, thereby reducing the productivity of the well.

To address this problem and to increase the flow of oil and natural gas to the well bore, companies have employed the well-known technique of fracturing the subterranean area around the well to create more paths for the oil and natural gas to flow toward the well. As described in more detail in the literature, this fracturing is accomplished by hydraulically injecting a fluid at very high pressure into the area surrounding the well bore. This fluid must then be removed from the fracture to the extent possible to ensure that it does not impede the flow of oil or natural gas back to the well bore. Once the fluid is removed, the fractures have a tendency to collapse due to the high compaction pressures experienced at well-depths, which can be more than 20,000 feet. To prevent the fractures from closing, it is well known to include a propping agent, also known as a proppant, in the fracturing fluid. The goal is to be able to remove as much of the injection fluid as possible while leaving the proppant behind to keep the fractures open. The term “proppant,” as used herein, refers to any non-liquid material that is present in a proppant pack and provides structural support in a propped fracture. The term “anti-flowback additive,” as used herein, refers to any material that is present in a proppant pack and reduces the flowback of proppant particles but still allows for production of oil at sufficient rates. The terms “proppant” and “anti-flowback additive” are not necessarily mutually exclusive, so a single particle type may meet both definitions. For example, a particle may provide structural support in a fracture, and it may also be shaped to have anti-flowback properties, allowing it to meet both definitions.

Scale deposition, such as inorganic and organic deposits in the well, can cause significant problems during fracturing operations. Following the hydraulic fracturing of a subterranean formation, producing fluids such as oil, gas, condensate, and water may flow from the reservoir through the conductive proppant pack in the fracture. As these fluids flow through the fracture to the wellbore, up towards the surface through the well, and then to production facilities, pressure and temperature changes can result in damaging deposits being formed within this production network. For example, within the fracture, water in the fracture formation can deposit “out-of-solution” minerals, such as barium sulfate, calcium carbonate, and other “inorganic scale” materials. Hydrocarbon-based fluids can also deposit undesirable residues, such as asphaltenes, paraffins, and waxes. Many of these damaging deposits are often encountered near or within the wellbore, but may also be encountered in surface facilities. These deposits can build up and eventually restrict the flow capacity of production conduits at the wellbore or production facilities. The slow buildup of mineral scales within the production network can significantly narrow the available flow capacity. If any of these damaging deposits are formed within the pore spaces of a conductive proppant pack in the fracture, significant permeability and conductivity reduction can occur, limiting fracture productivity and well production.

Because the damaging deposits can cause significant flow limitations in many parts of the production network, time consuming and sometimes very expensive intervention treatments may become necessary to mitigate or reverse these problems. These interventions typically involve pumping or placing a treatment-targeted, liquid inhibitor into the wellbore, fracture, or reservoir close to the source of the damaging deposits. The liquid treatment might target a specific deposit, such as sulfate scale, or might mitigate scale deposition. For comparatively “simple” onshore treatments, these treatments require periods of production shut-in and limited pumping services. However, treatments for offshore environments can be far more complex, requiring more costly services and carrying a much higher cost in production downtime. Another downside to such treatments is the length of efficacy. Since the treatments are liquid-based, they often slowly flow back to the wellbore with the production fluids, thereby removing any long-term placement benefits. With limited treatment lifetime, retreatments are often necessary to maintain the productivity of problem wells, adding further cost to the operators.

With all the limitations associated with liquid scale-inhibitor type treatments, it may be desirable to develop a source-targeted, easily-deployed, long-term and effective scale treatment or residue treatment. In recent years, several attempts have been made to develop solid-based, scale-control additives that can be placed within a proppant pack. Many of these materials suffer from one or more inefficiencies, such as being too weak mechanically, have insufficient release rates, or are too costly when compared to a proppant and liquid treatment alone. As such, it may be desirable to develop a proppant-based, slow-release chemical delivery system for a wide range of in-fracture chemical treatments. Furthermore, it may be desirable to provide proppants and anti-flowback additives to deliver chemicals to a well.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

According to one aspect of this disclosure, a proppant composition may include at least about 50% total silica and up to about 50% total alumina. The proppant composition may include a connected porosity greater than or equal to about 5%. The percent silica and alumina may be measured by x-ray fluorescence (XRF).

According to another aspect of this disclosure, a proppant precursor composition may include an alumina- or aluminosilicate-containing material and diatomaceous earth, wherein the diatomaceous earth may be greater than about 25 wt % of the proppant precursor composition. The proppant precursor composition, when fired or sintered, may produce a proppant having a connected porosity greater than or equal to about 5%. According to another aspect, the aluminosilicate may include an aluminosilicate clay, such as, for example, kaolin, ball clay, bauxitic kaolin, or a smectite clay. According to another aspect, the alumina may include a bauxite, such as, for example, gibbsite, boehmite, or diaspore.

According to another aspect of this disclosure, a method of making a proppant may include mixing an alumina- or aluminosilicate-containing material and diatomaceous earth to form a precursor composition, pelletizing the precursor composition, and sintering the pelletized precursor composition to form a sintered proppant having a connected porosity greater than or equal to about 5%. The precursor composition may include greater than or equal to about 25 wt % diatomaceous earth. According to another aspect, the method may include treating the sintered proppant with an active agent. Treating the sintered proppant may include treating the sintered proppant with a liquid containing the active agent, and drying the treated sintered proppant to remove the liquid leaving the active agent associated with the sintered proppant.

According to still another aspect, a method of treating a fracture site may include delivering a sintered proppant including at least about 50% total silica and up to about 50% total alumina, and having a connected porosity greater than or equal to about 5%, and an active agent to a well site, and dispersing the active agent from the sintered proppant within the well site. According to another aspect, the sintered proppant may be blended with a proppant that does not include an active agent.

It is to be understood that both the foregoing general description and the following detailed description are exemplary and explanatory only and are not restrictive of the invention, as claimed.

### BRIEF DESCRIPTION OF THE DRAWINGS

FIG. 1 shows an exemplary proppant according to this disclosure.

FIG. 2 shows an enlarged portion of the exemplary proppant.

FIG. 3 shows an enlarged portion of the exemplary proppant.

### DESCRIPTION OF EXEMPLARY EMBODIMENTS

Reference will now be made in detail to exemplary embodiments. Although certain examples or embodiments may be discussed in terms of kaolin as an alumina- or aluminosilicate-containing material, it is understood that these discussions are merely to facilitate description and are exemplary only, and that any alumina- or aluminosilicate-containing material may be used. As described herein, the terms “proppant,” “proppant composition,” “sintered proppant,” and “sintered proppant composition” may refer to the a composition of proppant particles. The individual proppant particles may make up the proppant, sintered proppant, proppant composition, or sintered proppant composition.

According to some embodiments of this disclosure, a proppant composition may include at least about 50% silica and less than about 50% alumina, as measured by XRF. The proppant composition may have a connected porosity greater than or equal to about 5%.

According to some embodiments, the proppant composition may have a total silica content ranging from about 50% to about 90%, such as, for example, ranging from about 65% to about 80%. According to some embodiments, the proppant composition may have a total alumina content ranging from about 10% to about 50%, such as, for example, ranging from about 20% to about 35%.

According to some embodiments, a proppant precursor composition includes an alumina- or aluminosilicate-containing material and diatomaceous earth, wherein the diatomaceous earth may be greater than or equal to about 25 wt % of the proppant precursor composition. The proppant precursor composition, when fired or sintered, may produce a proppant having a connected porosity greater than or equal to about 5%. According to another aspect, the aluminosilicate may include an aluminosilicate clay, such as, for example, kaolin, ball clay, bauxitic kaolin, or a smectite clay. According to another aspect, the alumina may include a bauxite, such as, for example, gibbsite, boehmite, or diaspora. As described herein, unless stated otherwise, weight percent or wt %, is determined based on the weight of a particular component over the total weight of diatomaceous earth and an alumina- or aluminosilicate-containing material in the proppant precursor composition.

According to some embodiments, the proppant precursor composition may include greater than or equal to about 30 wt % diatomaceous earth, greater than or equal to about 35 wt % diatomaceous earth, greater than or equal to about 40 wt % diatomaceous earth, greater than or equal to about 45 wt % diatomaceous earth, greater than or equal to about 50 wt % diatomaceous earth, greater than or equal to about 55 wt % diatomaceous earth, greater than or equal to about 60 wt % diatomaceous earth, greater than or equal to about 65 wt % diatomaceous earth, greater than or equal to about 70 wt % diatomaceous earth, or greater than or equal to about 75 wt % diatomaceous earth. According to some embodiments, the proppant precursor composition may include an amount of diatomaceous earth ranging from about 35 wt % to about 75 wt %, such as for example, ranging from about 35 wt % to about 50 wt %, ranging from about 40 wt % to about 60 wt %, ranging from about 45 wt % to about 55 wt %, ranging from about 50 wt % to about 75 wt %, ranging from about 50 wt % to about 60 wt %, or ranging from about 65 wt % to about 75 wt %.

According to some embodiments, the proppant precursor composition may contain diatomaceous earth structures including frustules having a median particle size ranging from about 1 μm to about 1000 μm, such as from about 10 μm to about 150 μm. According to some embodiments, a sintered proppant composition may include residual diatomaceous earth frustule structures that are visible via electron microscopy.

According to some embodiments, the proppant precursor composition, which fired or sintered, may form a porous proppant. According to some embodiments, the proppant may include a connected porosity greater than or equal to about 5%, such as, for example, greater than or equal to about 6%, greater than or equal to about 7%, greater than or equal to about 8%, greater than or equal to about 9%, greater than or equal to about 10%, greater than or equal to about 11%, greater than or equal to about 12%, greater than or equal to about 13%, greater than or equal to about 14%, greater than or equal to about 15%, greater than or equal to about 16%, greater than or equal to about 17%, greater than or equal to about 18%, greater than or equal to about 19%, greater than or equal to about 20%, greater than or equal to about 21%, greater than or equal to about 22%, greater than or equal to about 23% greater than or equal to about 24%, or greater than or equal to about 25%. Connected porosity may be measured using a helium pycnometer.

According to some embodiments, the proppant composition may have an average apparent density ranging from about 1.7 g/cc to about 2.35 g/cc. For example, the proppant composition may have an average apparent density ranging from about 1.75 g/cc to about 2.25 g/cc, ranging from about 1.8 g/cc to about 2.0 g/cc, ranging from about 1.9 g/cc to about 2.1 g/cc, ranging from about 2.0 g/cc to about 2.2 g/cc, ranging from about 2.0 g/cc to about 2.1 g/cc, ranging from about 2.1 g/cc to about 2.2 g/cc, ranging from about 2.0 g/cc to about 2.15 g/cc, ranging from about 2.05 g/cc to about 2.15 g/cc, ranging from about 2.15 g/cc to about 2.25 g/cc, ranging from about 2.0 g/cc to about 2.3 g/cc, or ranging from about 2.1 g/cc to about 2.3 g/cc.

According to some embodiments, the proppant composition may have an average absolute density ranging from about 2.2 g/cc to about 2.8 g/cc. For example, the proppant composition may have an average absolute density ranging from about 2.25 g/cc to about 2.75 g/cc, from about 2.3 g/cc to about 2.75 g/cc, from about 2.3 g/cc to about 2.7 g/cc, from about 2.4 g/cc to about 2.6 g/cc, from about 2.5 g/cc to about 2.6 g/cc, from about 2.6 g/cc to about 2.7 g/cc, or from about 2.7 g/cc to about 2.8 g/cc.

According to some embodiments, the proppant composition may have a crush test result of less than or equal to about 12% fines at 2,500 psi, such as, for example, less than or equal to about 10% fines, less than or equal to about 9% fines, less than or equal to about 8% fines, less than or equal to about 7.5% fines, less than or equal to about 7% fines, less than or equal to about 6.5% fines, less than or equal to about 6% fines, less than or equal to about 5.5% fines, less than or equal to about 5% fines, or less than or equal to about 4.5% fines at 2,500 psi.

According to some embodiments, the proppant composition may have a crush test result of less than or equal to about 25% fines at 5,000 psi, such as, for example, less than or equal to about 23% fines, less than or equal to about 22% fines, less than or equal to about 21% fines, less than or equal to about 20% fines, less than or equal to about 19% fines, less than or equal to about 18% fines, less than or equal to about 17% fines, less than or equal to about 16% fines, less than or equal to about 15% fines, less than or equal to about 14% fines, less than or equal to about 13% fines, less than or equal to about 12% fines, less than or equal to about 11% fines, or less than or equal to about 10% fines at 5,000 psi.

According to some embodiments, the silica content of the proppant composition may range from about 50% to about 90%, as measured by XRF, such as, for example, from about 65% to about 80%, or from about 70% to about 80%, or from about 70% to about 75%, as measured by XRF. In one embodiment, the alumina content of the proppant can range from about 10% to about 50%, as measured by XRF, such as, for example, from about 20% to about 35%, or from about 20% to about 30%, or from about 25% to about 30%, as measured by XRF.

According to some embodiments, the proppant composition may include greater than or equal to about 90% by weight of the proppant particles have a particle size greater than or equal to about 840 μm (20 mesh) and less than or equal to about 1700 μm (12 mesh). According to some embodiments, the proppant composition may include greater than or equal to about 90% by weight of the proppant particles have a particle size greater than or equal to about 600 μm (30 mesh) and less than or equal to about 1200 μm (16 mesh). According to some embodiments, the proppant composition may include greater than or equal to about 90% by weight of the proppant particles have a particle size greater than or equal to about 400 μm (40 mesh) and less than or equal to about 840 μm (20 mesh). According to some embodiments, the proppant composition may include greater than or equal to about 90% by weight of the proppant particles having a particle size greater than or equal to about 300 μm (50 mesh) and less than or equal to about 600 μm (30 mesh). According to some embodiments, the proppant composition may include greater than or equal to about 90% by weight of the proppant particles having a particle size greater than or equal to about 200 μm (70 mesh) and less than or equal to about 400 μm (40 mesh). According to some embodiments, the proppant composition may include greater than or equal to about 90% by weight of the proppant particles having a particle size greater than or equal to about 200 μm (70 mesh) and less than or equal to about 840 μm (20 mesh). According to some embodiments, the proppant composition may include greater than or equal to about 90% by weight of the proppant particles having a particle size greater than or equal to about 200 μm (70 mesh) and less than or equal to about 300 μm (50 mesh). According to some embodiments, the proppant composition may include greater than or equal to about 90% by weight of the proppant particles having a particle size greater than or equal to about 300 μm (50 mesh) and less than or equal to about 600 μm (20 mesh). According to some embodiments, the proppant composition may include greater than or equal to about 90% by weight of the proppant particles having a particle size greater than or equal to about 300 μm (50 mesh) and less than or equal to about 1,000 μm (18 mesh). According to some embodiments, the proppant composition may include greater than or equal to about 90% by weight of the proppant particles having a particle size greater than or equal to about 400 μm (40 mesh) and less than or equal to about 1,000 μm (18 mesh).

According to some embodiments, the proppant composition may include an active agent. According to some embodiments, the active agent may be chemically active to prevent the formation or buildup of inorganic deposits, such as, for example, scale deposits in the well or production network. According to some embodiments, the active agent may have functional chemical properties, such as, for example, oxidative functionality or enzyme breaker functionality. According to some embodiments, the active agent may include surfactant-based chemical properties. According to some embodiments, the active agent may be chemically active to prevent the buildup of organic deposits, such as, for example, waxes, asphaltenes, and paraffins. According to some embodiments, the active agent may be selected from the group consisting of phosphates, phosphonates, or combinations thereof. According to some embodiments, the active agent may include glutaraldehyde, quaternary ammonium chloride, tetrakis hydroxymethyl-phosphonium sulfate, choline chloride, tetramethyl ammonium chloride, chlorine chloride, sodium chloride, formic acid or salts thereof, sulfates, sulfonates, acetaldehyde, citric acid or salts thereof, acetic acid or salts thereof, thioglycolic acid or salts thereof, sodium erythorbate, laurel sulfate, ethylene glycol, acrylamide, sodium acrylate, sodium polycarboxylate, phosphoric acid or salts thereof, naphthalene, or combinations thereof.

According to some embodiments, the proppant composition may include from about 1 wt % to about 10 wt % active agent relative to the weight of the proppant, such as, for example, from about 1 wt % to about 5 wt %, from about 5 wt % to about 10 wt %, from about 3 wt % to about 7 wt %, from about 1 wt % to about 3 wt %, from about 3 wt % to about 5 wt %, from about 5 wt % to about 7 wt %, or from about 7 wt % to about 10 wt % active agent relative to the weight of the proppant. As described herein, the weight percent of the active agent is determined by the weight of the active agent in solution relative to the weight of the sintered proppant (on a solids basis).

According to some embodiments, a method of making a proppant may include mixing an alumina- or aluminosilicate-containing material and diatomaceous earth to form a precursor composition, pelletizing the precursor composition, and sintering the pelletized precursor composition to form a sintered proppant having a connected porosity greater than or equal to about 5%. The precursor composition may include greater than or equal to about 25 wt % diatomaceous earth. According to some embodiments, the method may include treating the sintered proppant with an active agent. Treating the sintered proppant may include treating the sintered proppant with a liquid containing the active agent, and drying the treated, sintered proppant to remove the liquid.

According to some embodiments, the precursor composition may include greater than or equal to about 25 wt % diatomaceous earth, greater than or equal to about 30 wt % diatomaceous earth, greater than or equal to about 35 wt % diatomaceous earth, greater than or equal to about 40 wt % diatomaceous earth, greater than or equal to about 45 wt % diatomaceous earth, greater than or equal to about 50 wt % diatomaceous earth, greater than or equal to about 55 wt % diatomaceous earth, greater than or equal to about 60 wt % diatomaceous earth, greater than or equal to about 65 wt % diatomaceous earth, greater than or equal to about 70 wt % diatomaceous earth, or greater than or equal to about 75 wt % diatomaceous earth. According to some embodiments, the precursor composition may include an amount of diatomaceous earth ranging from about 35 wt % to about 75 wt %, such as, for example, ranging from about 35 wt % to about 50 wt %, ranging from about 40 wt % to about 60 wt %, ranging from about 45 wt % to about 55 wt %, ranging from about 50 wt % to about 75 wt %, ranging from about 50 wt % to about 60 wt %, or ranging from about 65 wt % to about 75 wt %.

According to some embodiments, a method of treating a fracture site may include delivering a sintered proppant including at least about 50% total silica and up to about 50% total alumina, and having a connected porosity greater than or equal to about 5%, and an active agent to a well site, and dispersing the active agent from the sintered proppant within the well site. According to some embodiments, the sintered proppant may be blended with a proppant that does not include an active agent.

According to some embodiments, the sintered proppant may include a porous proppant. According to some embodiments, the sintered proppant may include a connected porosity greater than or equal to about 5%, such as, for example, greater than or equal to about 6%, greater than or equal to about 7%, greater than or equal to about 8%, greater than or equal to about 9%, greater than or equal to about 10%, greater than or equal to about 11%, greater than or equal to about 12%, greater than or equal to about 13%, greater than or equal to about 14%, greater than or equal to about 15%, greater than or equal to about 16%, greater than or equal to about 17%, greater than or equal to about 18%, greater than or equal to about 19%, greater than or equal to about 20%, greater than or equal to about 21%, greater than or equal to about 22%, greater than or equal to about 23%, greater than or equal to about 24%, or greater than or equal to about 25%.

According to embodiments, the sintered proppant may have an average apparent density ranging from about 1.7 g/cc to about 2.3 g/cc. For example, the sintered proppant may have an average apparent density ranging from about 1.75 g/cc to about 2.25 g/cc, ranging from about 1.8 g/cc to about 2.0 g/cc, ranging from about 1.9 g/cc to about 2.1 g/cc, ranging from about 2.0 g/cc to about 2.2 g/cc, ranging from about 2.0 g/cc to about 2.1 g/cc, ranging from about 2.1 g/cc to about 2.2 g/cc, ranging from about 2.0 g/cc to about 2.15 g/cc, ranging from about 2.05 g/cc to about 2.15 g/cc, ranging from about 2.15 g/cc to about 2.25 g/cc, ranging from about 2.0 g/cc to about 2.3 g/cc, or ranging from about 2.1 g/cc to about 2.3 g/cc.

According to some embodiments, the sintered proppant may have an average absolute density ranging from about 2.2 g/cc to about 2.8 g/cc. For example, the sintered proppant may have an average absolute density ranging from about 2.25 g/cc to about 2.75 g/cc, from about 2.3 g/cc to about 2.75 g/cc, from about 2.3 g/cc to about 2.7 g/cc, from about 2.4 g/cc to about 2.6 g/cc, from about 2.5 g/cc to about 2.6 g/cc, from about 2.6 g/cc to about 2.7 g/cc, or from about 2.7 g/cc to about 2.8 g/cc.

According to some embodiments, the sintered proppant may have an API crush test result of less than or equal to about 12% fines at 2,500 psi, such as, for example, less than or equal to about 10% fines, less than or equal to about 9% fines, less than or equal to about 8% fines, less than or equal to about 7.5% fines, less than or equal to about 7% fines, less than or equal to about 6.5% fines, less than or equal to about 6% fines, less than or equal to about 5.5% fines, less than or equal to about 5% fines, or less than or equal to about 4.5% fines at 2,500 psi

According to some embodiments, the sintered proppant may have an API crush test result of less than or equal to about 25% fines at 5,000 psi, such as, for example, less than or equal to about 23% fines, less than or equal to about 22% fines, less than or equal to about 21% fines, less than or equal to about 20 fines less than or equal to about 19% fines, less than or equal to about 18% fines, less than or equal to about 17% fines, less than or equal to about 16% fines, less than or equal to about 15% fines, less than or equal to about 14% fines, less than or equal to about 13% fines, less than or equal to about 12% fines, less than or equal to about 11% fines, or less than or equal to about 10% fines at 5,000 psi.

In some embodiments, the silica content of the proppant or sintered proppant may range from about 50% to about 90%, as measured by XRF. For example, the silica content of the proppant or sintered proppant may range from about 65% to about 80%, from about 70% to about 80%, or from about 70% to about 75%, as measured by XRF. According to some embodiments, the alumina content of the proppant may range from about 10% to about 50%, for example, from about 20% to about 35%, or from about 20% to about 30%, or from about 25% to about 30%, as measured by XRF.

According to some embodiments, the sintered proppant may include greater than or equal to about 90% by weight of the proppant particles having a particle size greater than or equal to about 400 μm (40 mesh) and less than or equal to about 840 μm (20 mesh). According to some embodiments, the sintered proppant may include greater than or equal to about 90% by weight of the proppant particles having a particle size greater than or equal to about 300 μm (50 mesh) and less than or equal to about 600 μm (30 mesh). According to some embodiments, the sintered proppant may include greater than or equal to about 90% by weight of the proppant particles having a particle size greater than or equal to about 200 μm (70 mesh) and less than or equal to about 400 μm (40 mesh). According to some embodiments, the sintered proppant may include greater than or equal to about 90% by weight of the proppant particles having a particle size greater than or equal to about 200 μm (70 mesh) and less than or equal to about 840 μm (20 mesh). According to some embodiments, the sintered proppant may include greater than or equal to about 90% by weight of the proppant particles having a particle size greater than or equal to about 200 μm (70 mesh) and less than or equal to about 300 μm (50 mesh). According to some embodiments, the sintered proppant may include greater than or equal to about 90% by weight of the proppant particles having a particle size greater than or equal to about 300 μm (50 mesh) and less than or equal to about 600 μm (20 mesh). According to some embodiments, the sintered proppant may include greater than or equal to about 90% by weight of the proppant particles having a particle size greater than or equal to about 300 μm (50 mesh) and less than or equal to about 1,000 μm (18 mesh). According to some embodiments, the sintered proppant may include greater than or equal to about 90% by weight of the proppant particles having a particle size greater than or equal to about 400 μm (40 mesh) and less than or equal to about 1,000 μm (18 mesh).

According to some embodiments, the sintered proppant may include an active agent. According to some embodiments, the active agent may be chemically active to prevent the formation or buildup of inorganic deposits, such as, for example, scale deposits in the well or production network. According to some embodiments, the active agent may have functional chemical properties, such as, for example, oxidative functionality or enzyme breaker functionality. According to some embodiments, the active agent may include surfactant-based chemical properties. According to some embodiments, the active agent may be chemically active to prevent the buildup of organic deposits, such as, for example, waxes, asphaltenes, and paraffins. According to some embodiments, the active agent may be selected from the group consisting of phosphates, phosphonates, or combinations thereof. According to some embodiments, the active agent may include glutaraldehyde, quaternary ammonium chloride, tetrakis hydroxymethyl-phosphonium sulfate, choline chloride, tetramethyl ammonium chloride, chlorine chloride, sodium chloride, formic acid or salts thereof, sulfates, sulfonates, acetaldehyde, citric acid or salts thereof, acetic acid or salts thereof, thioglycolic acid or salts thereof, sodium erythorbate, laurel sulfate, ethylene glycol, acrylamide, sodium acrylate, sodium polycarboxylate, phosphoric acid, or salts thereof, naphthalene, or combinations thereof.

According to some embodiments, the sintered proppant may include from about 1 wt % to about 10 wt % active agent relative to the weight of the sintered proppant, such as, for example, from about 1 wt % to about 5 wt %, from about 5 wt % to about 10 wt %, from about 3 wt % to about 7 wt %, from about 1 wt % to about 3 wt %, from about 3 wt % to about 5 wt %, from about 5 wt % to about 7 wt %, or from about 7 wt % to about 10 wt % active agent relative to the weight of the proppant.

According to some embodiments, the proppants (e.g., proppant compositions sintered proppants) described in this disclosure may include porous proppants. The porosity of the proppant may allow a chemical, such as an active agent, to be delivered to a fracture site in order to treat the site. For example, the active agent may have scale-inhibiting properties to control scale deposits within the site or the production networks, or may have surfactant or oxidative properties. According to some embodiments, the proppant may be treated with a liquid containing the active agent such that the liquid penetrates the pores of the proppant. The liquid may be dried, leaving the active agent within the pores of the proppant. Once the proppant is delivered to the fracture site, water or other fluids at the fracture site may disperse the active agent, releasing it from the proppant. Once released, the active agent may be distributed by the fluid throughout the site or production network to perform its function, such as, for example, scale control.

According to some embodiments, the proppants may have a relatively uniform in size and shape. A relatively uniform size and shape may facilitate a highly permeable and conductive proppant pack within the fracture. Although the exemplary proppants described in this disclosure may be discussed in terms of spherical or relatively spherical proppants, it is understood that any appropriate proppant shape may be used, such as, for example, rod-shaped proppants.

The exemplary proppants may also have sufficient mechanical properties, such as hardness and strength, to withstand the large closure pressures exerted by the surrounding rock in the fractures. Ceramic proppants may be useful for some fractures, such as, for example, relatively deep fractures because these proppants may have sufficient strength to withstand the pressures within hydraulic fractures, where other proppants may fail, such as proppant sand. The strength of the proppants may be tailored based on the type and proportion of minerals selected during manufacture. The strength requirements can, for example, be tailored to suit relatively deeper hydraulic fractures or shallower hydraulic fractures. According to some embodiments, a proppant's strength may be increased by increasing the total alumina (Al₂O₃) content of the proppant.

According to some embodiments, prior to forming the proppants, a precursor composition may be pelletized into small particles. For example, pelletization may occur via a “dry” high speed mixing process or a wet fluidized process. Although either method can be used to make proppant pellets, the suitability of the process may depend on the source minerals being used in the proppant pellet composition. The pelletized precursor particles may be heat-treated by, for example, sintering to form the proppant. According to some embodiments, the pelletized precursor material may be processed, such as through extrusion, to form rod-shaped bodies that are then heat-treated to form a rod-shaped proppant.

According to some embodiments, a proppant may be effective as a solid, chemical-delivery additive to prevent damaging inorganic and/or organic deposits from forming within a hydraulic fracture or in a production network. The proppant may have desirable characteristics, such as size, shape, and strength suitable to maintain conductivity and withstand the pressure stresses of the hydraulic fracture. The proppant may also have a porous structure that may be used to retain the chemical for delivery, which may be released when the proppant is injected in the fracture.

According to some embodiments, the proppant may have sufficient properties to function as a chemical carrier and to release the carried chemical under controlled conditions, such as, for example, controlled release or slow release. The chemical may include an active agent having desired chemical properties to react with other materials at the well site. For example, an exemplary active agent may prevent undesirable deposits, such as scale, waxes, paraffins, or asphaltenes from forming or building up in the wellbore or the production network. To facilitate chemical carrying or controlled release, the proppants may have a porous structure capable of storing the chemicals during the fracture treatment and proppant placement. The internal structure may also allow for the stored chemicals to be released or to “desorb” after placement in the proppant pack at the fracture site. For example, the stored chemicals may be released or desorbed during dynamic flow conditions, such as when the production liquid flows through the proppant pack.

According to some embodiments, a carrying function for the proppant may be achieved by creating open or connected porosity within the proppant particles. Open porosity may allow the chemical to penetrate the proppant's porous structure during manufacture. When the chemical penetrates the porous structure it may be retained by the proppant for later release in the proppant pack or fracture. It can be difficult to introduce sufficient porosity into a proppant to retain an effective amount of the chemical, while still maintaining sufficient mechanical strength for the proppant to withstand the pressures of the fracture. For example, the volume, size, shape, complexity, and interconnectedness of the pores may determine the amount of chemical that can be absorbed by the proppant and delivered to the fracture site. These properties may also determine the release properties, such as release rates, of the infused chemicals over time. According to some embodiments, larger pore diameters or shallower pores may allow for faster release rates and more chemical to be stored by the proppant, whereas smaller pore diameters and deeper, more interconnected pore networks may have slower release rates over time.

According to some embodiments, the proppant particles may be formed from various blends of diatomaceous earth and alumina- or aluminosilicate-containing material. Without wishing to be bound to a particular theory, it is believed that the porous nature of diatomaceous earth may facilitate and maintain the porous nature of the proppant, creating a network of pores that can retain an active agent for delivery to the fracture site.

Diatomaceous earth (also called “diatomite” or “DE”) is generally known as a sediment-enriched in biogenic silica (i.e., silica produced or brought about by living organisms) in the form of siliceous skeletons (frustules) of diatoms. Diatoms are a diverse array of microscopic, single-celled, golden-brown algae generally of the class Bacillariophyceae that possess an ornate siliceous skeleton of varied and intricate structures including two valves that, in the living diatom, fit together much like a pill box.

Diatomaceous earth forms from the remains of water-borne diatoms and, therefore, diatomaceous earth deposits may be found close to either current or former bodies of water. Those deposits are generally divided into two categories based on source: freshwater and saltwater. Freshwater diatomaceous earth is generally mined from dry lakebeds and may be characterized as having a low crystalline silica content and a high iron content. In contrast, saltwater diatomaceous earth is generally extracted from oceanic areas and may be characterized as having a high crystalline silica content and a low iron content. Diatomaceous earth may also be processed and treated for a wide range of application markets.

Diatomaceous earth generally contains a mix of complex structured, microfossil skeletons that provide a relatively high natural porosity. The natural porosity of diatomaceous earth may allow it to absorb a large volume of liquid, such as, for example, up to 30% by weight. Because of its natural porosity and absorption, diatomaceous earth has been widely used in the filtration industry and for chemical clean-up.

Diatoms are generally characterized by a hollow interior and a perforated surface. Diatomaceous earth may take the form of siliceous frustules of diatoms, the majority of which have sizes ranging from about 0.75 μm to about 1,000 μm, such as from about 10 μm to about 150 μm. For example, the diatomite may have a particle size distribution ranging from about 5 μm (d₁₀, defined as the size at which 10 percent of the particle volume is accounted for by particles having a diameter less than or equal to this value) to about 82 μm (d₉₀, defined as the size at which 90 percent of the particle volume is accounted for by particles having a diameter less than or equal to this value). The unique porous silica structure of diatomite may allow for high absorptive capacity and surface area, chemical stability, and low bulk density.

Kaolin is a common component in manufacturing for proppants for medium to deep hydraulic fracture treatments. Kaolin is sometimes referred to as china clay or hydrous kaolin, and contains predominantly the mineral kaolinite, together with small concentrations of various other minerals. Kaolinite may also be generally described as an aluminosilicate, aluminosilicate clay, or hydrous aluminosilicate (Al₂Si₂O₅(OH)₄).

Kaolin clays were formed in geological times by the weathering of the feldspar component of granite. Primary kaolin clays are those which are found in deposits at the site at which they were formed, such as those obtained from deposits in South West England, France, Germany, Spain, and the Czech Republic. Sedimentary kaolin clays are those which were flushed out from the granite matrix at their formation site and were deposited in an area remote from their formation site, such as in a basin formed in the surrounding strata.

According to some embodiments, diatomaceous earth and kaolin may be used to form a proppant having sufficient mechanical properties and porosity to withstand the pressures of a fracture while also allowing the proppant to deliver chemicals to the fracture to prevent the formation or buildup of undesirable deposits. Without wishing to be bound by a particular theory, it is believed that the kaolin imparts mechanical strength to the proppant, and that the diatomaceous earth imparts porosity and chemical-carrying properties. The inventors surprisingly discovered that varying the ratio of diatomaceous earth and kaolin allows for the creation of a proppant-based, slow release, chemical carrier additive for delivering chemicals to a fracture site.

According to some embodiments, a precursor composition used to form a proppant may include a mixture of diatomaceous earth, an alumina- or aluminosilicate-containing material, and may optionally include a binder. According to some embodiments, the binder may include methyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulphonates, phosphates, alginates, and combinations thereof. The precursor composition may be mixed using a dry, high speed mixer process (Eirich) to form green proppant pellets. The green proppant pellets may then be dried and/or sintered to create a finished proppant. According to some embodiments, the proppant may be a porous proppant.

According to some embodiments, the proppants described in this disclosure may be used by themselves to create a proppant pack. According to some embodiments, the proppants described in this disclosure may be used in conjunction with other proppant particles as part of a proppant pack.

According to some embodiments, the proppant may be treated with a chemical, such as an active agent. The treatment may include treating the proppant with a chemical-containing liquid such that the chemical adsorbs to the proppant. For example, the treatment may include a mixing the proppant with the liquid, spraying the liquid on the proppant, or submerging the proppant in the liquid, such that the chemical-containing liquid is imbibed into the porous structure of the proppant. According to some embodiments, the treatment may optionally include treating the proppant under vacuum conditions. Without wishing to be bound to a particular theory, it is believed that treating the liquid under vacuum conditions may help the liquid penetrate deep into the pores of the proppant. According to some embodiments, the treatment may occur under pressurized conditions, such that pressure forces the liquid into the pores of the proppant.

According to some embodiments, the proppant may be dried after the treatment to create a chemical-delivery proppant. The drying step may remove the liquid from the pores, leaving the residual chemical adsorbed to the proppant. This adsorption may make the chemical available for delivery in a field application, such as at a fracture site. According to some embodiments, the chemical may include an active agent, such as, for example, a scale-controlling agent or an agent to control paraffin, wax, or asphaltene deposits. According to some embodiments, the active agent may include a phosphate-based or phosphonate-based scale inhibitor.

After the chemical-delivery proppant is placed within the proppant pack, for example, at a fracture site, the active agent may be “released” from the proppant. The release of the active agent may be facilitated by contact with formation water or other fluid within the fracture or within the production network. The release of the active agent may “protect” the fracture, wellbore, and production network from inorganic or organic deposits, such as, for example, damaging scale deposition or organic deposit buildup.

According to some embodiments, preventative chemicals, other than phosphates or phosphonates, may be included in the chemical-containing liquid. For example, the active agent may be selected to control any inorganic deposits, such as scale deposition, or organic deposits, such as waxes, asphaltenes, and paraffins. Exemplary chemicals and active agents may include, but are not limited to, glutaraldehyde, quaternary ammonium chloride, tetrakis hydroxymethyl-phosphonium sulfate, choline chloride, tetramethyl ammonium chloride, chlorine chloride, sodium chloride, formic acid or salts thereof, sulfates, sulfonates, acetaldehyde, citric acid or salts thereof, acetic acid or salts thereof, thioglycolic acid or salts thereof, sodium erythorbate, laurel sulfate, ethylene glycol, acrylamide, sodium acrylate, sodium polycarboxylate, phosphoric acid or salts thereof, naphthalene, or combinations thereof.

According to some embodiments, a porous chemical-delivery proppant may deliver active agents having functional chemical properties to the fracture site, such as, for example, oxidative or enzyme breakers. Delivery of active agents having functional chemical properties may assist in breaking fracture fluids. According to some embodiments, the active agent may have surfactant-based chemical properties. Chemicals with surfactant-based properties may help promote fluid clean-up or prevent emulsions from forming in the fracture or in the process equipment.

According to some embodiments, a chemical-delivery proppant may be blended with a conventional proppant to create a blended proppant composition. For example, the chemical-delivery proppant and the conventional proppant may be mixed at a manufacturing plant before being transported to a well location. The blended proppant composition may be delivered to a fracture location using, for example, a solids metering delivery screw or other known in-situ delivery method. Blending the chemical-delivery proppant with another non-chemical delivery proppant may help optimize the strength of the resulting proppant pack or may tailor the amount of active agent delivered to the fracture site. According to some embodiments, the blended proppant pack may include more than one chemical-delivery proppant so that multiple types of active agents may be delivered to the fracture site.

According to some embodiments, a chemical-delivery proppant can be added at any concentration suitable to a particular fracture treatment to tailor the amount of active agent delivered to the site. According to some embodiments, a blended proppant composition may include less than or equal to about 10% by weight of the chemical-delivery proppant.

According to some embodiments, a chemical-delivery proppant may be added the fracture site or used to create a blended proppant composition at any part of the fracture treatment and in any concentration. The mixture ratio of chemical-delivery proppant to conventional proppant may be varied across the fracture site to improve the delivery distribution of the active agent. For example, a chemical-delivery proppant may be added at a relatively low concentration throughout the course of a fracture treatment in some applications to disperse the active agent. According to some embodiments, a chemical-delivery proppant may be added as a tail-in to the proppant pack, such as, for example, 25% by weight of the blended proppant composition, although any tail-in amount of chemical-delivery proppant may be used depending on the application. According to some embodiments, a higher concentration of the chemical-delivery proppant may be added near-wellbore zone relative to the fracture away from the wellbore zone. It is understood that any concentration of the chemical-delivery proppant could be added to a proppant pack and/or that the chemical-delivery proppant could be added at any pumping stage of the fracturing treatment to achieve the desired protection or treatment result for a particular well or application.

According to some embodiments, a proppant or blend of proppants may include two or more different chemical-delivery proppants. For example, one chemical-delivery proppant may prevent scale formation while another chemical-delivery proppant may prevent wax or paraffin deposits from building up in the well or production facilities.

In addition to treating hydraulic fractures, chemical-delivery proppants may also be used in combined fracture/gravel packs (sometimes referred to as “Frac ‘n’ Pack” or “Frac-packs”) for sand control applications. Conventional proppants have been used in fracture/gravel packs and in stand-alone gravel pack treatments. When used in fracture/gravel packs or stand-alone gravel packs, the chemical-delivery proppants may include any beneficial chemistry that is suitable for the gravel packing or sand control application and may be blended with the fracture/gravel pack or stand-alone gravel pack in any desired ratio according to the application requirements. Proppants used in gravel packing may be subjected to relatively lower closure stresses within propped hydraulic fractures. The relatively lower closure stresses may allow for higher concentrations of the chemical-delivery proppant to be used for an application, including, for example, up to 100% of the pack. In gravel pack applications, the strength requirement may be less important when compared to the other requirements, such as narrow size distribution, high sphericity, and cleanliness of the proppant.

According to some embodiments, the chemical-delivery proppant may be used in formations where proppant sand control techniques are employed because the water production from these formations can be relatively high, which may assist in releasing the active agent from the chemical-delivery proppant. The high water production may facilitate the distribution of the chemical from the chemical-delivery proppant, thereby increasing its effectiveness.

### Example 1

An exemplary proppant was prepared by mixing diatomaceous earth, such as DiaFil® 615, commercially available from Imerys World Minerals, Inc., with kaolin in 50:50 ratio by weight. A typical chemical composition for DiaFil® 615 is shown in Table 1.

TABLE 1

| SiO₂ | Al₂O₃ | Fe₂O₃ | P₂O₅ | CaO | MgO | Na₂ + K₂O |
|---|---|---|---|---|---|---|
| 89.0% | 4.0% | 1.7% | 0.2% | 1.4% | 0.6% | 1.7% |

Polyvinyl alcohol (PVA) binder was added at 2 wt % relative to the total weight of diatomaceous earth and kaolin. The mixture was granulated using a 10 lb. lab-scale Eirich mixer to form a broad mesh size distribution of “green” proppant-like pellets. The green pellets were screened such that a 12/40 mesh distribution was retained. The retained distribution was fired in a static furnace for one hour at 1200° C. The fired pellets were then screened to form a 20/40 mesh distribution of proppant. The 20/40 mesh distribution of proppant was then analyzed.

To assess the available connected porosity of the proppants, the proppant density was measured both in a liquid using oil/Le Chatelier Flask to obtain the apparent density, and in helium using a He Pycnometer to obtain the absolute density. The difference between the apparent density and the absolute density was used to determine the internal porosity of the proppant particles. The apparent density from two formulation runs ranged from 2.05 g/cc to 2.15 g/cc with an average apparent density to 2.10 g/cc. The absolute density of the two runs ranged from 2.50 g/cc to 2.51 g/cc, with an average absolute density of about 2.51 g/cc. The internal porosity was calculated by taking the difference between the absolute and apparent densities and dividing the difference by the absolute density. Based on this calculation, the porosity for these two formulation runs ranged from about 14% to about 18% open porosity, with an average of about 16% internal porosity.

This available open porosity allows for a chemical to be infused into the structure of the proppant. The chemical release potential of these particles was approximated by the size and rate at which bubbles were generated by liquid displacement of trapped air. For the two production runs described in this example, the bubbles appeared very small to the naked eye and continue “bleeding” out for many hours, which suggests that the proppants can be used to provide a slow-release chemical delivery system.

The mechanical strength of the proppants was evaluated using the standard API proppant crush test, as described in API RP 19C at stresses of 2,500 psi and 5,000 psi. For proppant pack in these tests included 100% of the proppant described in this example. For the two formulation runs of this example, the crush test result at 2,500 psi ranged from 4.3% to 4.8% fines with an average crush test result of 4.6% fines. At a stress of 5,000 psi, the crush test result ranged from 20.6% to 21.3% fines, with an average crush test result of 21.0% fines.

The proppant described in this example may blended with a conventional ceramic proppant having a higher strength to create a blended proppant pack. The blended proppant pack may exhibit a lower “effective” crush test result relative to the pack comprising 100% of the proppant of this example because the conventional, higher-strength proppant may mitigate the crush.

The aforementioned preferred embodiment, is thought to give the best combination of strength and chemical delivery properties, but many different types (marine vs. freshwater), blends (e.g., 25:75 to 75:25 as diatomaceous earth:kaolin), and pre-treatments (calcination) of diatomaceous earth, blended with kaolin have been attempted, as well as different firing conditions (1200-1500° C.). In summary, adding more diatomaceous earth (e.g., 75:25 as diatomaceous earth:kaolin) increases porosity, but decreases strength, while adding less diatomaceous earth (e.g., 25:75 as diatomaceous earth:kaolin) increases strength but decreases porosity and a higher firing temperature significantly increases strength but significantly reduces porosity. Without wishing to be bound by theory, it is believed that the higher firing temperature may “melt” the complex microfossil structure of the diatomaceous earth, thereby “closing in” the porosity.

### Example 2

Two runs of proppants were prepared as described in Example 1, except that the blend of diatomaceous earth to kaolin was 25:75 by weight. The fired proppant of this example had an apparent density ranging from 2.26 g/cc to 2.30 g/cc, with an average apparent density of 2.28 g/cc. The absolute density ranged from 2.59 g/cc to 2.61 g/cc, with an average absolute density of 2.60 g/cc. Based on the absolute and apparent densities, the approximate porosity ranged from about 11.9% to about 12.7%, with an average porosity of about 12.3%. The crush test result at 2,500 psi was about 4.5% fines, and the crush test result at 5,000 psi ranged from 11.3% to 20.0% fines, with an average crush test result of 15.7% fines at 5,000 psi.

As shown in this example, increasing the weight percent of kaolin increased the crush strength of the proppant, but decreased the available porosity.

As shown in Examples 1 and 2, by varying the ratios of diatomaceous earth and kaolin and the firing temperatures, it is possible to create a proppant having relatively high strength and porosity for chemical delivery in various application environments, such as a fracture. For example, increasing the amount of diatomaceous earth in the blend, or firing at a relatively lower temperature may increase the porosity of the proppant or may result in a relatively lower crush strength. Similarly, increasing the amount of kaolin in the blend, or firing at a relatively higher temperature, may increase the crush strength but may also lower the porosity of the proppant.

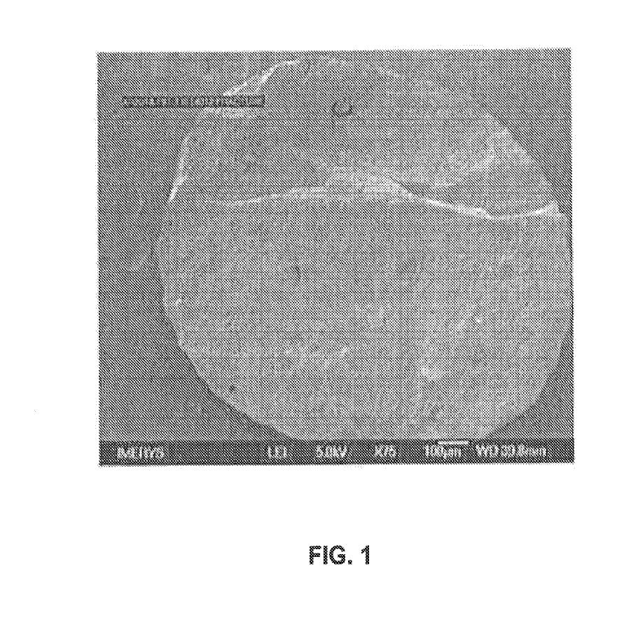

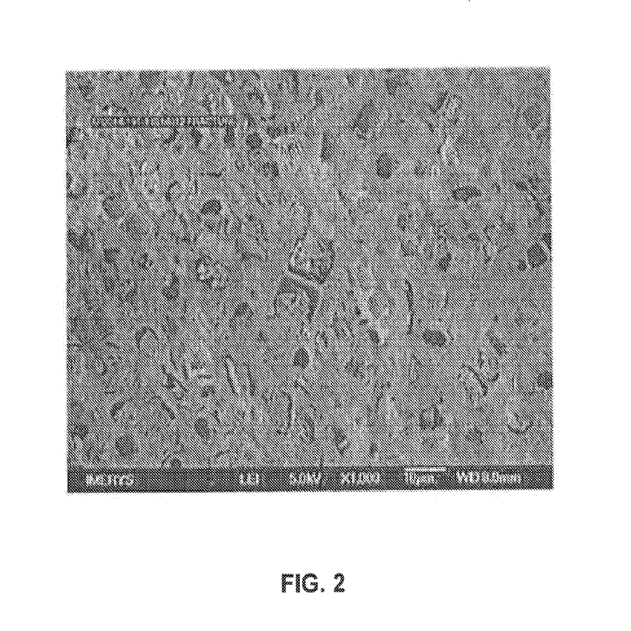

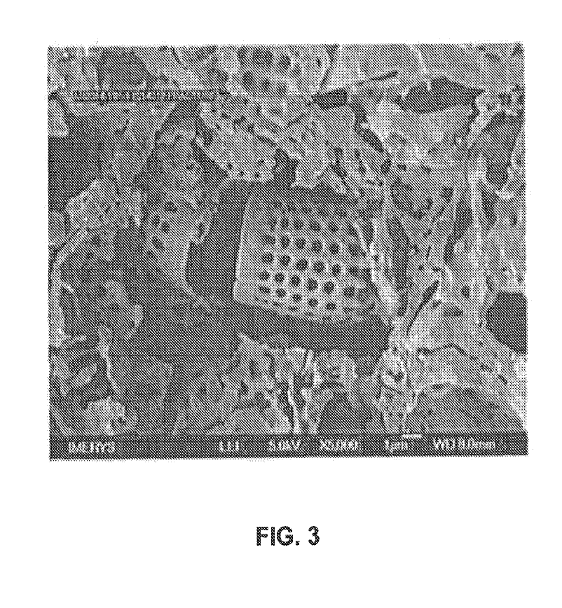

FIGS. 1-3 show exemplary proppants prepared using the described methods.

According to some embodiments, a lower-strength, higher-porosity proppant may be desirable for applications where scale or residue control takes precedence over the proppant strength requirement. Conversely, in applications where proppant strength may take precedence over scale or residue control, increasing the kaolin percent in the blend, or firing at a higher temperature may yield a more desirable proppant. As shown in Examples 1 and 2, the blends and firing temperatures may be varied to obtain certain desired properties, such as porosity or crush strength, to accommodate the requirements for a specific application.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A proppant composition, comprising:
at least about 50% total silica; and
up to about 50% total alumina,
wherein the proppant composition has a connected porosity greater than or equal to about 5%.

2. The proppant composition of claim 1, wherein the proppant composition has a total silica content ranging from about 50% to about 90%.

3. The proppant composition of claim 1, wherein the proppant composition has a total silica content ranging from about 65% to about 80%.

4. The proppant composition of claim 1, wherein the proppant composition has a total alumina content ranging from about 10% to about 50%.

5. The proppant composition of claim 1, wherein the proppant composition has a total alumina content ranging from about 20% to about 35%.

6. The proppant composition of claim 1, wherein the proppant composition has a connected porosity greater than or equal to about 10%.

7. The proppant composition of claim 1, wherein the proppant composition has a connected porosity greater than or equal to about 15%.

8. The proppant composition of claim 1, wherein the proppant composition has an average apparent density ranging from about 1.75 g/cc to about 2.25 g/cc.

9. The proppant composition of claim 1, wherein the proppant composition has an average absolute density ranging from about 2.25 g/cc to about 2.75 g/cc.

10. The proppant composition of claim 1, wherein the proppant composition has a crush test result of less than or equal to about 10% fines at 2,500 psi.

11. The proppant composition of claim 1, wherein the proppant composition has a crush test result of less than or equal to about 20% fines at 5,000 psi.

12. The proppant composition of claim 1, wherein the proppant composition comprises a total alumina content of greater than or equal to about 40%.

13. The proppant composition of claim 1, wherein the proppant composition comprises a total alumina content of greater than or equal to about 50%.

14. The proppant composition of claim 1, wherein the proppant composition comprises a total alumina content ranging from about 40% to about 90%.

15. The proppant composition of claim 1, wherein greater than or equal to about 90% by weight of the proppant particles have a particle size greater than or equal to about 400 μm and less than or equal to about 840 μm.

16. (canceled)

17. (canceled)

18. The proppant composition of claim 1, further comprising an active agent.

19. The proppant composition of claim 18, wherein the active agent is selected from the group consisting of phosphates, phosphonates, or combinations thereof.

20. The proppant composition of claim 18, wherein the active agent comprises from about 1 wt % to about 10 wt % relative to the weight of the proppant composition.

21. (canceled)

22. A proppant precursor composition, comprising:
an alumina- or aluminosilicate-containing material; and
diatomaceous earth,
wherein the diatomaceous earth comprises greater than about 25 wt %

23-49. (canceled)

50. A method of treating a fracture site, the method comprising:
delivering a sintered proppant comprising at least about 50% total silica and up to about 50% total alumina, and having a connected porosity greater than or equal to about 5%, and an active agent to a well site; and
dispersing the active agent from the sintered proppant within the well site.

51-64. (canceled)
